(19) United States
(12) Patent Application Publication
(10) Pub. No.: US 2018/0327238 A1
(43) Pub. Date: Nov. 15, 2018

(54) GRAPPLE WITH REACH LIMITATION

(71) Applicant: Pierce Pacific Manufacturing, Inc., Portland, OR (US)

(72) Inventors: Dominic H. Tremblay, Verdun (CA); Severn D. Durand, Portland, OR (US); Brandon K. Gray, Damascus, OR (US); John Evans, West Linn, OR (US)

(21) Appl. No.: 15/875,731

(22) Filed: Jan. 19, 2018

Related U.S. Application Data
(60) Provisional application No. 62/504,071, filed on May 10, 2017.

(51) Int. Cl. B66F 9/075; B66F 9/22; B66F 9/18

(52) U.S. Cl. CPC B66F 9/0755; B66F 9/22; B25J 9/1638; B66F 9/184; B66F 9/07559

(57) ABSTRACT

An loader is provided that has a body which is pivotable in a mid-section, a primary linkage pivotally mounted to the body, a secondary linkage pivotally mounted to the primary linkage, and a grapple pivotally mounted to the secondary linkage to carry a load positioned forward of the body. The improvement includes means for determining the positions of the primary and secondary linkages, and means for measuring the weight of a load being carried by the grapple. The control system has the capability of receiving from the means the positions of the primary and secondary linkages and the weight of the load and calculating whether the load is in an unstable position. If the load is unstable, the operator is prevented from moving the load to a more unstable position, but is not prevented from moving the load to a more stable position.

### CROSS-REFERENCE TO RELATED APPLICATIONS

This application claims priority to U.S. Provisional Application No. 62/504,071, filed May 10, 2017, the entire disclosure of which is incorporated herein by reference.

### FIELD OF THE INVENTION

The invention relates to a grapple reach limitation system for a vehicle, designed to increase max payload rating while ensuring the safety of the operator.

### BACKGROUND

Articulated wheel loaders converted as log loaders have been in use for many years. One example is the Paralift, manufactured by Pierce Pacific Manufacturing, Inc., assignee of the present disclosure. Such loaders often have a grapple connected to a boom, which engages a payload such as a load of logs, lumber, telephone poles, or other oblong objects. These loaders are extremely maneuverable to operate around saw mills, lumber mills or other facilities where such loads need to be moved within the site from one place to another. One example is to load or unload the objects onto a truck, railcar, container or other load-hauling vehicle.

Especially when fitted with a grapple, the boom permits the grapple to be extended out to grasp a pile of logs or other oblong objects from a pile and maneuver them over to a load-hauling vehicle The boom enables the loader to reach out to grasp a load from a pile, convey the load to a loading vehicle, and reach out over the vehicle to release the load.

Because articulated wheel loaders are so maneuverable and, when fitted with a boom and grapple, are so versatile, in certain settings and with particularly heavy loads, they can become unstable when the load is extended out forward from the loader. Experienced operators can normally determine when this may be an issue but even they may tend to come close to the edge of safe parameters. Also, because every load is different, particularly with logs, it is difficult for the operator to know the exact weight of the load and therefore how far the loaded grapple can be extended. It is also common that the surface on which the loader is operating might not be entirely flat.

Normally an experienced operator can predict the stability behavior of the machine by observing the load size, and will keep the load close to the machine to ensure proper stability if he evaluates the current load exceeds safe capacity. Tipping of the vehicle or the load is of course extremely dangerous to the operator and those in the area. FIG. 1 illustrates the problem. It can be seen in the shaded area may be problematic if the load is too heavy or of the load is extended too far forwardly of the center of gravity of the loader. Counterweights (not shown) can be added to the rear of the loader but are limited by the overall capacity of the machine and will limit the available capacity for payload.

Prior art efforts to control the operation of loading equipment have tended to focus on efficiency or productivity. For example, U.S. Pat. No. 8,145,355 teaches a system for selecting the most efficient path of travel for the articulated arm of a hydraulic excavator. This is particularly helpful when the movements are repetitive and therefore susceptible to automation. A similar effort for a so-called skid steer loader is described in published U.S. patent application number 2016/0060842. However, neither of these prior art efforts has focused on how to make these operations as safe and stable as possible, particularly when being used with a grapple system. Similarly, neither prior art effort appears to address stability problems inherent in articulated wheel loaders. Such vehicles steer by pivoting in the middle, and performing a pivot while carrying a heavy load can change the balance of the machine. The payload is located in front of the both axles. The location of the load generates a moment about the front axle, a rotating force lifting the rear axle. This is countered by the center of gravity of the rear of the machine and distance from the front axle. Pivoting the machine reduces the distance between the front and rear axles and thus reducing the counter force to the moment from the payload. This issue is a unique stability issues on articulated wheel loaders.

### BRIEF DESCRIPTION OF THE DRAWINGS

FIG. 1 is a schematic side elevation view of a prior art articulated wheel loader with a log loader conversion, showing in shading the area that may be problematic from a stability standpoint if a heavy load is being maneuvered too far forward of the center of gravity of the loader;

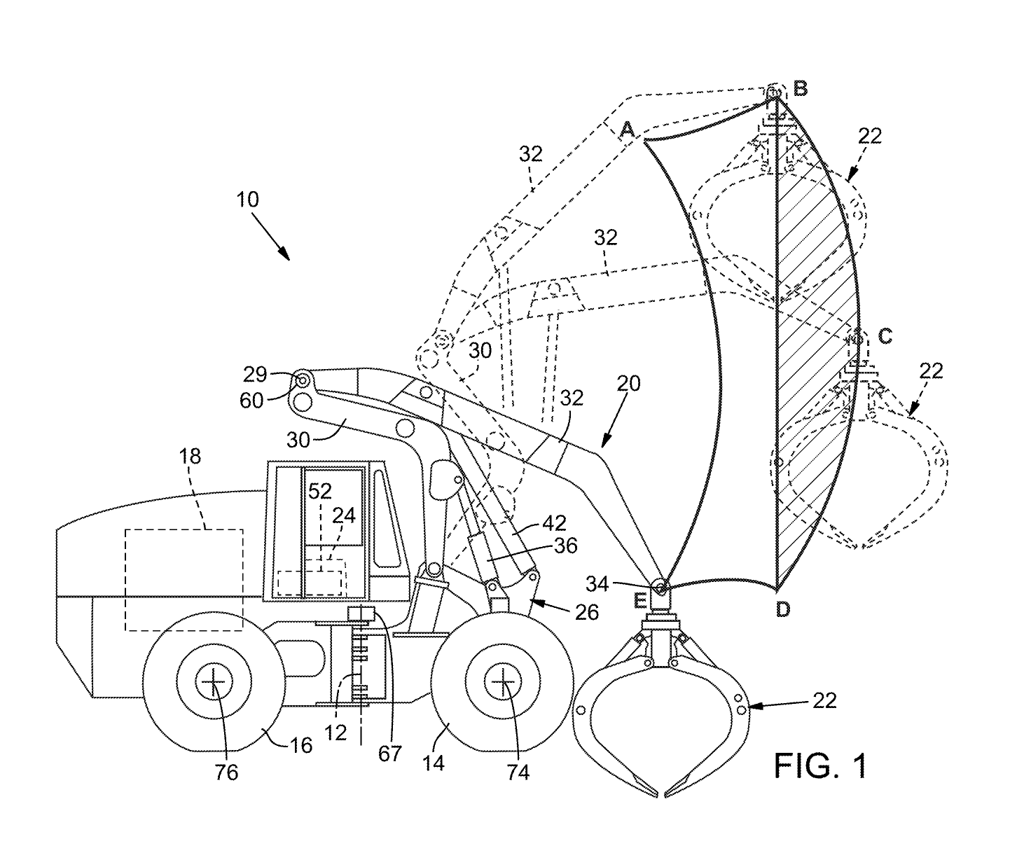

FIG. 2 is a side elevation view of a preferred embodiment of an articulated wheel loader;

FIG. 3 is a top plan view of the embodiment of FIG. 2, with the grapple wide open;

FIG. 4 is a front view of the embodiment of FIG. 2., with the grapple wide open;

FIG. 5 is a top plan view of the embodiment of FIG. 2, showing the articulated wheel loader pivoting; and

FIG. 6 is a flow chart showing how the embodiment of FIG. 2 may operate.

### DETAILED DESCRIPTION OF THE PREFERRED EMBODIMENT

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

An articulated wheel loader may be provided that has a body which is pivotable in a mid-section. A primary linkage is pivotally mounted to the body, a secondary linkage is pivotally mounted to the primary linkage, and a grapple is pivotally mounted to the secondary linkage for carrying a load forward of the body. The position of the primary and secondary linkages may be controlled by at least one primary linkage cylinder and at least one secondary linkage cylinder extending between the body and the primary and secondary linkages, respectively. The improvement includes a control system for informing an operator of an unstable condition, including means for determining the positions of the primary and secondary linkages, and means for measuring the weight of a load being carried by the grapple. The control system has the capability of receiving from the means the positions of the primary and secondary linkages and the weight of the load and calculating whether the load is in an unstable position. If the position of the load is unstable, the operator is prevented from moving the load to a more unstable position, but is not prevented from moving the load to a more stable position.

The means for determining the positions of the primary and secondary linkages may include an inclinometer mounted to each linkage or it may be in the form of position sensors disposed in the primary linkage cylinder and the secondary linkage cylinder. The primary linkage may be mounted to the body at a first pivot point and the secondary linkage may be mounted to the primary linkage at a second pivot point, in which case the means for determining the positions of the primary and secondary linkages may include encoders mounted to each of the pivot points.

The means for measuring the weight of the load being carried by the grapple may include pressure sensors in the primary linkage cylinder and the secondary linkage cylinder, or it may be in the form of a load cell sensor mounted proximate the grapple. An angle-reading device may also be provided for determining a degree of pivoting of the body.

A front end loader may be provided that includes a body, a primary linkage pivotally mounted to the body, a secondary linkage pivotally mounted to the primary linkage, and a load-carrying assembly pivotally mounted to the secondary linkage. A pair of primary linkage cylinders may be mounted between the body and the primary linkage to control the position of the primary linkage, and a pair of secondary linkage cylinders may be mounted between the body and the secondary linkage to control the position of the secondary linkage. A control system is included for preventing an operator from moving the load into an unstable position. The control system includes means for determining the angular disposition of the linkages, and means for measuring the weight of a load being carried by the load-carrying assembly. The control system receives the angular disposition of the linkages and the weight of the load from the means for determining the angular disposition and the means for determining the weight of the load, respectively. The control system has the capability of triangulating the position of the linkages to calculate whether the load is in an unstable position and, if the position of the load is unstable, preventing the operator from moving the load to a more unstable position. The control system normally does not prevent the operator from moving the load to a more stable position.

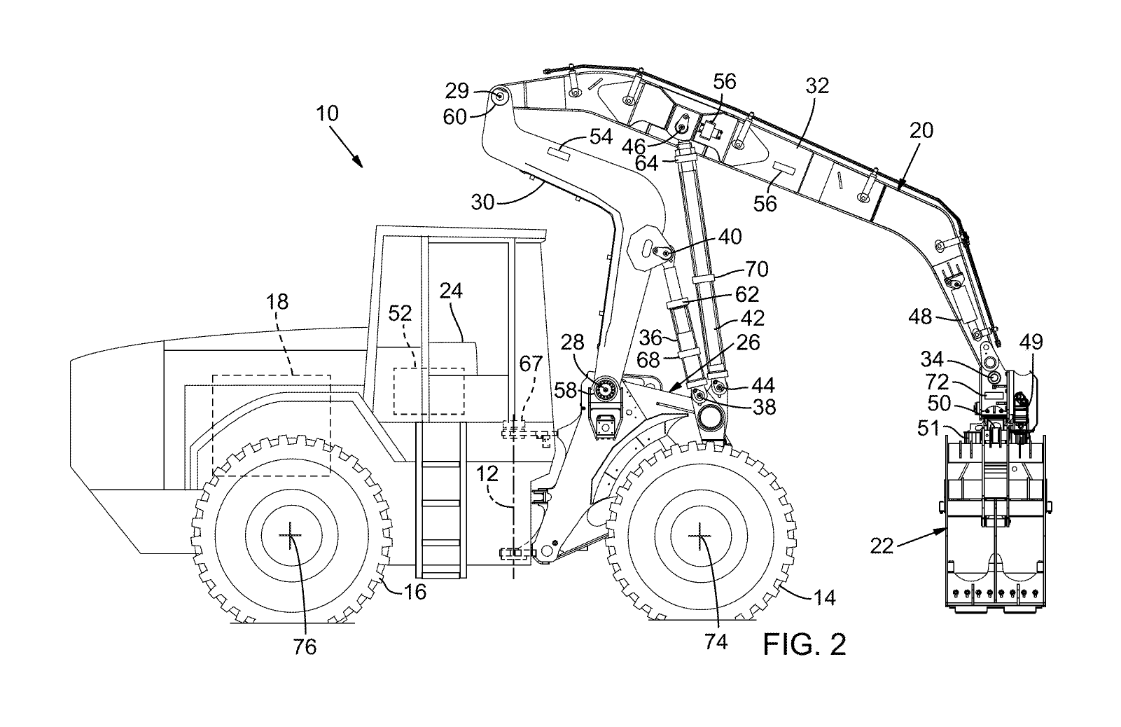

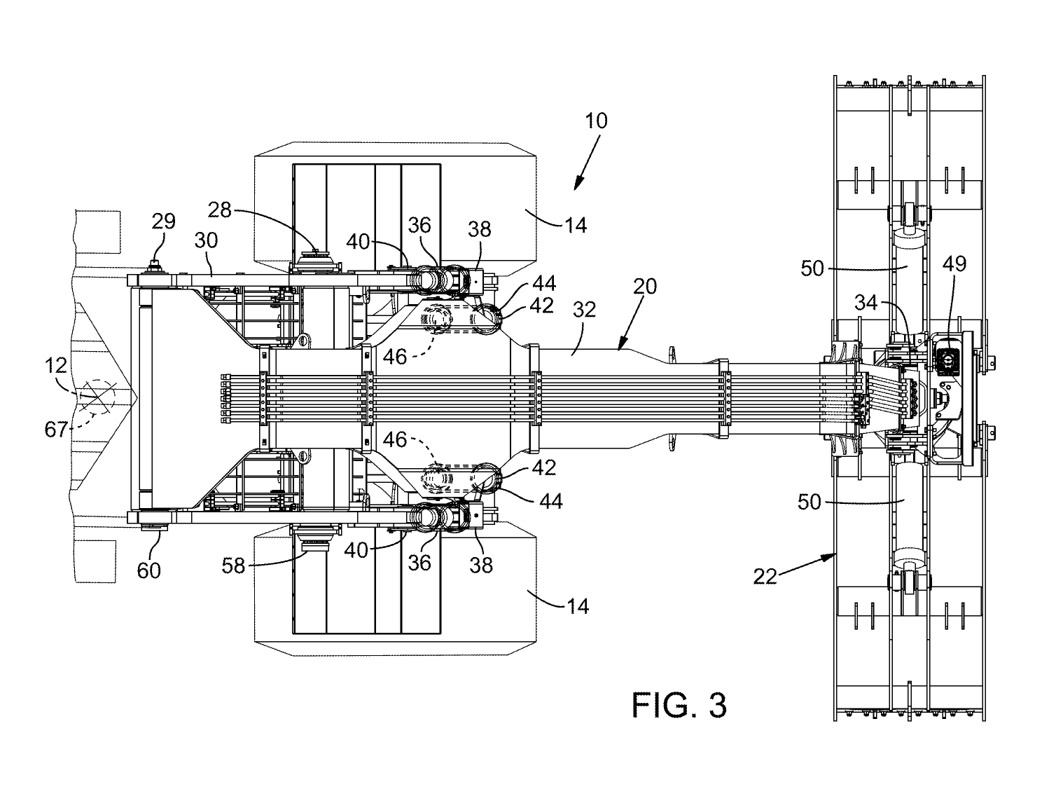

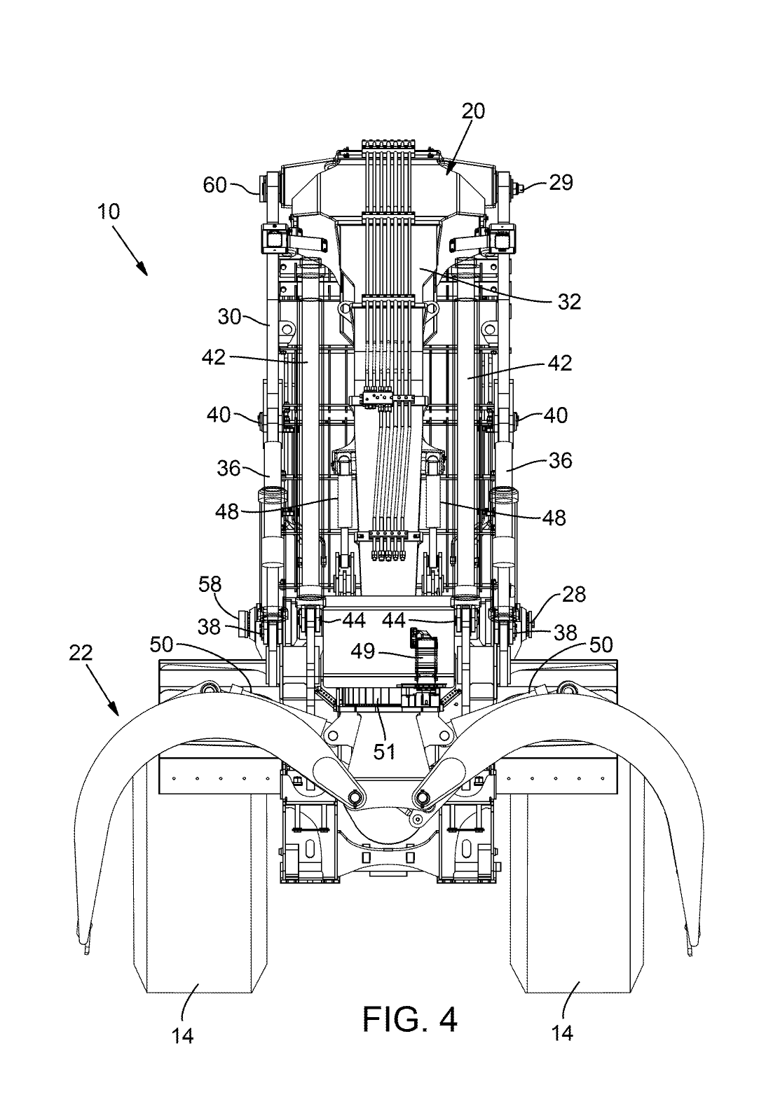

FIGS. 2-5 show an articulated wheel loader with which the present invention may be used. While incorporation into an articulated wheel loader is particularly advantageous, the invention may also be used with other types of loaded vehicles, where a boom attachment that can adjust lifting positions horizontally may be utilized. However, the following description will focus on an articulated wheel loader such as that shown in FIGS. 2-5 and identified generally with the numeral 10. For simplification, articulated wheel loader 10 will sometimes be referred to as a loader.

Loader 10 is a four-wheeled vehicle with a central pivot, generally indicated at 12. With the front portion of loader being maneuverable through central pivot 12, the loader is extremely maneuverable even though neither the front wheels 14 nor the rear wheels 16 typically do not pivot or turn. The weight of loader 10 is usually balanced by an engine 18, rear frame and counterweight (not shown), being disposed on the far rear end of the loader in order to facilitate the lifting of a heavy load through the use load-carrying assembly, normally in the form of a forwardly-disposed boom 20 and a grapple 22. The operator's seat is at 24, centrally located to provide maximum visibility and protection for the operator.

Boom 20 is typically mounted to a front or tower portion of the loader at a first pivot point 28. The tower portion of the loader is indicated at 26, immediately in front of the operator's seat 24. Boom 20 typically includes a primary linkage 30 that extends between first pivot point 28 and second pivot point 29, which mounts the primary linkage to a secondary linkage 32. Secondary linkage 32 typically extends to grapple 22 and is mounted to the grapple at a grapple pivot point 34.

The position of boom 20 is controlled by a series of hydraulic cylinders. A first pair of cylinders, called the primary linkage cylinders 36, extend from a rearward portion of loader tower 26 to the primary linkage 30 at first and second primary linkage cylinder attachment points 38 and 40, respectively. A second pair of cylinders, called the secondary linkage cylinders 42, extend from a more forward portion of tower 26 to the secondary linkage 32 at first and second secondary linkage cylinder attachment points 44 and 46.

As mentioned earlier, secondary linkage 32 mounts to grapple 22 at grapple pivot point 34. The pivoting of grapple 22 with respect to secondary linkage 32 is controlled by a pair of grapple pivot cylinders 48, and the rotation of the grapple is controlled by a hydraulic motor 49 that drives a gear 51. The opening and closing of the grapple is controlled by a pair of grapple control cylinders 50.

The control system for loader 10 will now be described. As alluded to earlier, an object of the depicted embodiment is to provide a safety system that will warn the operator in the event the loader is becoming unstable due to the load being extended too far forward of the center of gravity. In the depicted embodiment, the control system actually prevents the load from being moved farther forward once certain unstable conditions are being approached, but that is not a necessary feature of the depicted embodiment or the invention.

A computer is provided and is shown schematically at 52. It receives input from various systems positioned around loader 10 in order to be able to triangulate the position of the boom components and the load, and to measure the weight of the load so that stable and unstable positions can be determined. For example, inclinometers 54 and 56 may be mounted to the primary linkage 30 and secondary linkage 32, respectively, in order to determine the position of the linkages and to feed that data to computer 52. An alternative would be to position encoders 58 and 60, respectively, on first pivot point 28 and second pivot point 29 to measure the angulation of the linkages. An encoder 60 might also be positioned on grapple pivot point 34.

Yet another alternative would be to include a position sensor in primary linkage cylinder 36, shown at 62, in secondary linkage cylinder 42, shown at 64, and grapple pivot cylinders 48, shown at 66. The inclinometers, encoders and position sensors would all work to provide the computer with data that would enable the computer to triangulate the precise position of the linkages and the grapple. Normally only one such system would be used, although redundancy is an option and may be desirable in certain applications. All have been shown in the figures simply for the purpose of illustration.

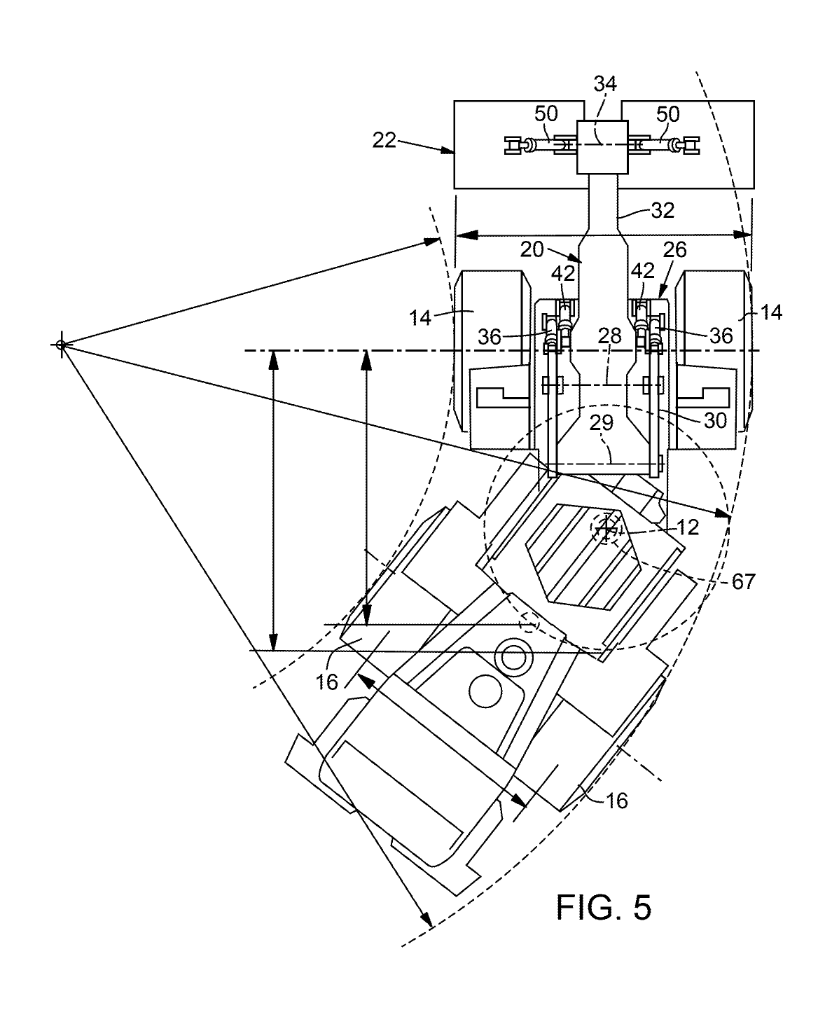

An angle-reading device 67 may be mounted to central pivot 12, as best shown in FIG. 5. This reads the steer angle of the loader, which is necessary, as the steer angle can dramatically affect the stability of the loader and the permitted extension of the loaded grapple. However, while it is helpful to improve the overall performance of the system, reading the steering angle is not a mandatory feature of the depicted embodiment. If the angle sensor is not used, the computer may have to assume the worst case scenario, which might limit the load the loader can carry or otherwise affect performance.

In order to determine how far forward of the center of gravity the load can be carried, the computer also needs to know the precise weight of the load. This can be determined in several different ways. One way is to include pressure sensors 68 and 70 in primary linkage cylinders 36 or secondary linkage cylinders 42, respectively. Again, redundancy in having pressure sensors in both the primary and secondary linkage cylinders is possible and may be desirable in some applications. Both are depicted in the figures, again for purposes of illustration.

Another way to determine the precise weight of the load is to include a load cell sensor 72 in grapple 22. Again, having both a load cell sensor and cylinder pressure sensors is normally not necessary, but the redundancy may be desirable in certain applications.

Articulated Wheel Loaders have a front axle 74 and a rear axle 76, neither of which typically pivots. As shown in FIG. 5, loader 10 typically steers by the central pivot 12, which separates the front and rear halves of the loader. This pivot allows the front and rear axles 74 and 76 to be parallel or angled relative to each other. When the axles are parallel, the steering angle of the loader is considered zero and the machine travels straight. As steering angle is introduced at the central pivot, the angle between the axles determines steering direction. The point at which projected axle lines intersect when angled is the turning radius of the machine at that steering angle. The turning radius of the machine varies as the central pivot rotates, more rotation will generate a smaller turning radius. A result of steering the loader in this manner also changes the center of gravity. At full steering angle, the overall loader length shortens and effectively moves the center of gravity closer to front axle 74. This is important because the distance of the center of gravity to the front axle determines what the maximum payload can be before the loader becomes unstable. When the loader is not loaded, the center of gravity is a downward force that is reacted by the front and rear axles 74 and 76, determined by the distance of the center of gravity to each axle. When a load is introduced, a second downward-acting force is added to the down ward force of the loader center of gravity acting in front of front axle 74. These two forces are now reacted by the front and rear axles. The loader is considered to be unstable when the rear reactive force is at a determined minimum value. When the center of gravity of the loader relative to front axle moves, the calculation is drastically different.

The depicted and described loader 10 may be able to carry a heavier payload because there will be less of a concern about instability. And, it may be able to do that without adding an additional counterweight to the rear of the loader. To facilitate the use of the system of the preferred embodiment, an electronic control algorithm is provided to triangulate the position of the loader components, optionally the steer angle, and to factor in an accurate measurement of the weight being carried. The electronic control algorithm limits the loader's horizontal reach to a calculated value, “K.” That predetermined K-value can be fixed or variable, depending on operating characteristics such as the current payload and optionally, the current steer angle. This is accomplished by the evaluation of the data being fed to the computer by the angle-reading device, inclinometers, encoders, position sensors, pressure sensors and/or load cell sensor. The computer evaluates current conditions of operation and dictates the permitted relative position of the primary and secondary linkages.

Specifically, angle-reading device 67 provides the steering position of the loader to computer 52 so the computer can evaluate the affect this position has on the permitted position of the loaded grapple. Inclinometers 54 and 56 on primary linkage 30 and secondary linkage 32, respectively, feed to the computer the current positions of the linkages. Pressure sensors 68 and 70 in the primary and secondary linkage cylinders 36 and 42, respectively, transmit the current pressure on the barrels of the cylinders, which allows the system to estimate the load being carried by grapple 22 so the computer can evaluate the current conditions of operation, and coordinate the allowed relative position of the linkages.

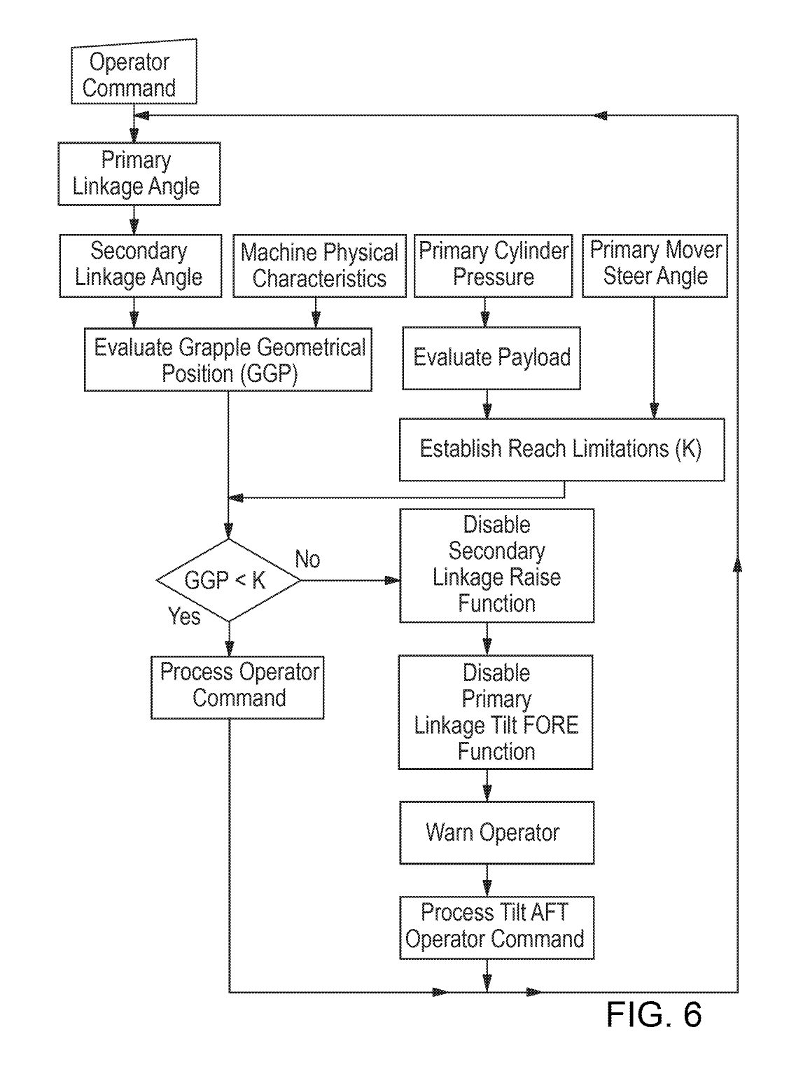

As shown in FIG. 6, operator commands, which conventionally operate the primary and secondary linkages independently and without limitation, will be conditioned by the electronic control algorithm in computer 52. For example, as the operator attempts to manipulate the load through the operation of the linkages, if the grapple geometric position (“GPP”) is less than the K-value, the operator will have full control of the movement of the load being held by the grapple. If, on the other hand, the GPP is not less than the K-value, the secondary linkage “Raise” function is disabled, as is the primary linkage “Tilt Fore” function. The disabling of these features ensures that the load will not be moved into an unstable position. At the same time these are disabled, the operator is warned of the hazardous condition, either by an alarm, a bright warning light, or both. Note that the entire function of the control is not disabled, as the operator can “TILT AFT” in order to move the load into a safer position so that operations are not further inconvenienced or delayed. Of course, the computer may be programmed to entirely shut down the loader so that operator (and the operator's supervisor) can appreciate the hazardous condition that was just experienced.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. An articulated wheel loader having a body that is pivotable in a mid-section thereof, a primary linkage pivotally mounted to the body, a secondary linkage pivotally mounted to the primary linkage, a grapple pivotally mounted to the secondary linkage to carry a load positioned forward of the body, the position of the primary and secondary linkages being controlled by at least one primary linkage cylinder and at least one secondary linkage cylinder extending between the body and the primary and secondary linkages, respectively, wherein the improvement comprises:
control system for informing an operator of an unstable condition, including means for determining the positions of the primary and secondary linkages, means for measuring the weight of a load being carried by the grapple, the control system having the capability of receiving from the means the positions of the primary and secondary linkages and the weight of the load and calculating whether the load is in an unstable position and, if the position of the load is unstable, preventing the operator from moving the load to a more unstable position, but not preventing the operator from moving the load to a more stable position.

2. The articulated wheel loader of claim 1 wherein the means for determining the positions of the primary and secondary linkages comprises an inclinometer mounted to each linkage to determine the inclination of the linkages.

3. The articulated wheel loader of claim 1 wherein the means for determining the positions of the primary and secondary linkages comprises position sensors in the primary linkage cylinder and the secondary linkage cylinder.

4. The articulated wheel loader of claim 1 wherein the primary linkage is mounted to the body at a first pivot point and the secondary linkage is mounted to the primary linkage at a second pivot point, and the means for determining the positions of the primary and secondary linkages comprises encoders mounted to each of the first pivot point and the second pivot point.

5. The articulated wheel loader of claim 1 wherein the means for measuring the weight of the load being carried by the grapple comprises pressure sensors in the primary linkage cylinder and the secondary linkage cylinder.

6. The articulated wheel loader of claim 1 wherein the means for measuring the weight of the load being carried by the grapple comprises a load cell sensor mounted proximate the grapple.

7. The articulated wheel loader of claim 1, further comprising an angle-reading device for determining a degree of pivoting of the body.

8. A loader comprising:
a body;
a primary linkage pivotally mounted to the body;
a secondary linkage pivotally mounted to the primary linkage;
a load-carrying assembly pivotally mounted to the secondary linkage;
a pair of primary linkage cylinders mounted between the body and the primary linkage to control the position of the primary linkage;
a pair of secondary linkage cylinders mounted between the body and the secondary linkage to control the position of the secondary linkage; and
a control system for preventing an operator from moving the load into an unstable position, comprising means for determining the relative disposition of the linkages, and means for determining the weight of a load being carried by the load-carrying assembly, the control system receiving the relative disposition of the linkages and the load weight from the means for determining the relative disposition and the means for determining the weight of the load, respectively, the control system having the capability of triangulating the position of the linkages to calculate whether the load is in an unstable position and, if the position of the load is unstable, preventing the operator from moving the load to a more unstable position, but not preventing the operator from moving the load to a more stable position.

9. The loader of claim 8 wherein the means for determining the relative disposition of the primary and secondary linkages comprises an inclinometer mounted to each linkage to determine the inclination of the linkages.

10. The loader of claim 8 wherein the means for determining the relative dispositions of the primary and secondary linkages comprises position sensors in the primary linkage cylinder and the secondary linkage cylinder.

11. The loader of claim 8 wherein the primary linkage is mounted to the body at a first pivot point and the secondary linkage is mounted to the primary linkage at a second pivot point, and the means for determining the relative disposition of the primary and secondary linkages comprises encoders mounted to each of the first pivot point and the second pivot point.

12. The loader of claim 8 wherein the means for measuring the weight of the load being carried by the grapple comprises pressure sensors in the primary linkage cylinder and the secondary linkage cylinder.

13. The loader of claim 8 wherein the means for measuring the weight of the load being carried by the load carrying assembly comprises a load cell sensor mounted proximate the load carrying assembly.
